(19) United States
(12) Patent Application Publication
(10) Pub. No.: US 2020/0380613 A1
(43) Pub. Date: Dec. 3, 2020

(54) COMPUTING SOFTWARE VOICE ACTIVATED, SPEECH RECOGNITION APPLICATION METHOD FOR COMMON BUSINESS PAYROLL ACCOUNTING OPERATIONS FUNCTIONALITY FOR STATIONARY, MOBILE AND PORTABLE COMMUNICATION AND COMPUTING DEVICES

(71) Applicant: Daniel J. Hikel, Truckee, CA (US)

(72) Inventor: Daniel J. Hikel, Truckee, CA (US)

(21) Appl. No.: 15/911,096

(22) Filed: Mar. 3, 2018

(51) Int. Cl. G06Q 40/00; G06Q 40/06; G10L 15/30

(52) U.S. Cl. CPC G06Q 40/125; G06Q 40/123; G10L 15/30; G06Q 40/06

(57) ABSTRACT

A voice activated, payroll and or accounts payable software platform to calculate, record, store, execute and deposit direct deposit payments to employees, Federal and State Tax agencies, retirement plans, workers compensation insurance companies and other similar and related common business expense payments and deductions over internet and wireless networks using existing mobile and portable computing and communication devices.

A Computing software voice activated, speech recognition application method for common business payroll accounting operations, financial banking transactions, electronic funds transfers, (EFT's), tax payments and other financial transaction payments, for use on a mobile smartphone, transitory and/or non-transitory, stationary, electronic communication and computing device.

### TECHNICAL FIELD

This patent application relates generally to a voice activated, voice biometric, business payroll method for electronic banking through electronic currency transfers of legal tender for common business functions including, but not limited to, payroll and accounts payable, tax payments and deposits, and other electronic financial processing services on a mobile transitory or non-transitory digital computing and communication devices. (A.k.a. smartphone or iPhone®, Amazon© Echo, and/or Apple® homepod).

### BACKGROUND

Business payroll and bill pay—external currency transfer (electronic banking) functions are common and readily available software functions for desktop, laptop and also mobile smartphone computing device accessibility commonly provided by payroll software platforms by Intuit, Quickbooks©, Paychex©, Gusto©, Patriot© and other software brands are some of the most commonly used.

Electronic banking and mobile banking secure platforms are provided by most nationally recognized banks and financial institutions for most common banking functions. Electronic direct deposit payroll methods currently exist for employer to withdraw funds from a specified account and deposit funds into designated employee banking account through the use of Electronic Funds Transfer (EFT) and Financial Electronic Data Interchange (FEDI), which is described as follows; The electronic transmission of payments and payment related information in standard formats between companies and/or their banks. FEDI includes electronic formats for invoices, payment initiation, and remittance information processed through a financial institution or communications intermediary.

Online platforms for employer payroll tax remittance requirements also currently exist through the United States Treasury Department, IRS, Electronic Federal Tax Payment System (EFTPS) and various state employer tax departments. Different jurisdictions apply different withholding amounts based on varying state requirements for employer/employee income tax withholdings.

A network of remote, secure and interconnected database servers consist of and can include, employer information, employee information, federal and state employer tax server access and information, containing detailed information on employee(s) rate, type of pay, hourly or salary, tax identification number for employer and employee(s), required federal and state withholding percentages and/or amounts, employee(s) income tax withholding percentages, 401(k) or other retirement contributions/deductions and other voluntary withholdings/contributions, exist and are currently accessible and process executable with current available software from said business payroll software platforms, electronic banking platforms and federal and state business and employer tax payroll platforms.

Voice activated data command search and voice activated text messaging are common applications for mobile speech to text and speech to search software. This type of software function is based on a semantic, biometric based algorithm(s) and is commonly available in current mobile and other computing device software applications for functions other than description of the invention.

The ability to query detailed business related data through a voice recognized, semantic search interface is also available as software based, computing function that exists for business and non-business related functions. Such type of methods use voice biometrics, voice recognition, speech recognition and other similar terms.

The ability to voice activate and command existing software processes, to connect to data storage servers with typical computing hardware designs and existing software applications for storage and retrieval are prevalent in most types of inquiry, search, and some forms of sales purchasing payment execution but such methods do not exist in a full, voice activated payroll system or systems for executing common business accounts and/or other accounts payable functions.

### SUMMARY

This patent application describes systems and techniques for executing and paying employer payroll, including all necessary federal and state tax liability deductions and payments, retirement contributions, and other voluntary deductions, contributions and payments, through the use of secure voice biometric, voice activated authenticated software from an employers/first party mobile transitory or non-transitory computing and/or communication device, (i.e. smartphone, tablet, laptop, portable wearable device) and connect to a pre-programmed, secure payroll data server, financial institution server and tax repository servers, to execute payroll function and other common business accounts payable functions.

The process will include access to employers/first party user bank account to electronically transfer and deposit appropriate funds into employee(s)/recipient personal bank account, retirement account and such, through existing electronic funds transfer system.

The process will also be able to make appropriate electronic funds transfers (EFT's) to United States Treasury Department of Internal Revenue Service server, Electronic Federal Tax Payment System (EFTPS) and appropriate state tax department server(s) for required withholdings at designated and required timeframes.

The process will connect through common and secure internet, (LAN), Local Area Network, (WAN), Wide Area Network, wireless, wi-fi, and mobile cell phone radio frequency network signals to secure servers with pre-programmed existing payroll software application methods to execute functions through voice recognized commands received from a first party mobile communications computing device (i.e. smartphone) or other non-transitory, voice recognition computing device such as Amazon© Echo and Apple© Homepod.

The server parties involved will be as such, first party/employer data content server with necessary pre-stored and programmed pay rate, withholdings, and other information on employee(s)/recipient, employer bank account server, employee bank account server, employee retirement account server, federal and state tax entity account server and other voluntary contribution servers as described.

The location for direct deposit and transaction notification of the employee(s)/recipient may be identified based on, at least one of an Internet Protocol (IP) address of a computing device of the employee(s)/recipient and can include the employee bank account server.

The process may work on various voice command methods, and payments made on either predetermined or pre-calculated methods or on an as needed basis calculation dependent upon employer/employee(s) requirements of rate of pay and required withholdings and voluntary contributions.

Also described herein is a method performed by one or more processing devices, which includes activating a pre-programmed data content server with information necessary to execute payroll functionality in its full requirements for direct deposit Electronic Funds Transfer (EFT) to employee(s)/recipient, and other necessary electronic funds transfers through various bank, financial institutions and tax repository servers.

All or part of the systems and techniques described herein may be implemented as a computer program product that includes instructions that are stored on one or more storage device(s) and that are executable on one or more processing devices or servers. All or part of the systems and techniques described herein may be implemented as an apparatus, method, or electronic system that may include one or more processing devices and memory to store executable instructions to implement the stated functions.

The details of one or more implementations are set forth in the accompanying drawings and the description below. Other features, objects and advantages will be apparent from the description and drawings, and from the claims.

### DESCRIPTION OF DRAWINGS

FIG. 1 is a block diagram that shows and example system for voice activated mobile payroll.

FIGS. 2 through 7 collectively show an example system and sequence of events for voice activated mobile payroll, electronic funds transfer, accounts payable and other operable voice activated functions of the system.

FIGS. 8-10 collectively show swimlane diagram sequences of events.

FIG. 11 shows a generic smartphone diagram and generic data content server for executing process.

### DETAILED DESCRIPTION

Described herein is a system for executing voice activated payroll, accounts payable, tax payment and other payroll deduction payments from a first party user/ employer mobile device or voice recognized non-transitory computing and communications device.

Payroll requirements of employer for employee may be based on a pre-determined base salary or variable rate of payment including but not limited to hours worked multiplied by a given or pre-determined hourly rate of pay. (That rate may vary depending upon hours worked to include overtime hours calculated at a common method such as time and one-half hourly rate dependent upon federal overtime laws and regulations, as well as other predetermined methods.)

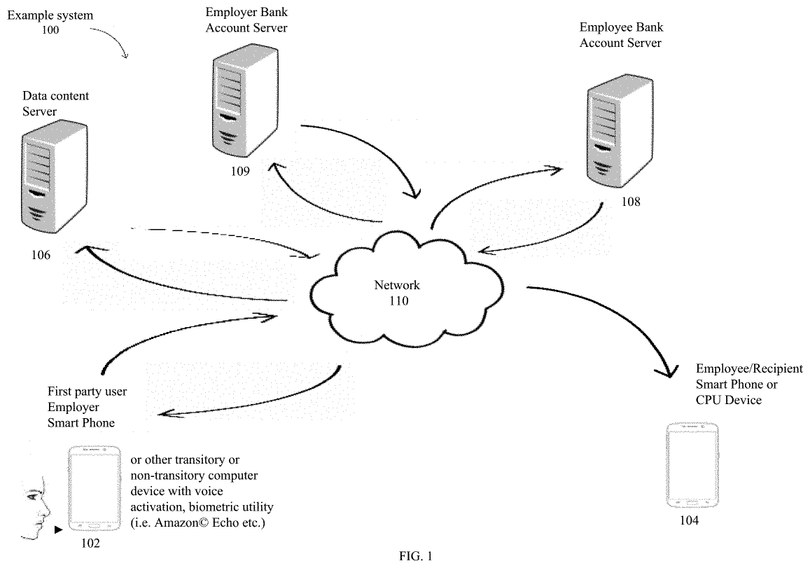

FIG. 1 is a block diagram that shows an example system 100 for voice activated mobile payroll and voice activated, electronic funds transfer. Using the system 100, for example, a first party user/employer from varying locations can execute necessary payroll business function for an employee/recipient in a second location. The system 100 can include one or more computer systems with which the first party user (e.g. an employer) can communicate and complete the payroll process initiated by voice activated commands via a mobile communication/computing device including but not limited to a smartphone, tablet or other computing device including non-transitory desktop and laptop devices with appropriate voice biometric functionality.

In the example shown in FIG. 1, the First Party user/employer 102 is executing a voice activated, electronic funds transfer payroll amount with appropriate and required deductions, both required and voluntary, to the recipient, an employee 104. When executing the payroll function through voice activation, the first party user/employer 102 can provide payroll withholding information to recipient/employee, as well as any other payment information. In some implementations, during which the first party user/employer 102 activates the payroll system though voice biometric methods, the first party user/employer 102 can also pay the necessary tax withholding amounts and contributions as required by Federal and state employer tax code. Other deductions such as 401(k), retirement plans, health savings and health insurance plans can also be made simultaneously if needed as pre determined by normal payroll accounting data input and function.

The terms first party user/employer 102 and employee/recipient, 104 when used in this document can represent the computing devices with which individuals (who are employers and employees) can be connected to the Internet, a local area network (LAN), wide area network (WAN), wireless frequencies (wi-fi), mobile telephone signal network and/or through other known electronic means of communication.

In some examples, payroll taxes can be imposed by the taxing authority, United States Department of Treasury, IRS, and other state jurisdictions and regulatory agencies. Payroll taxes can vary by jurisdiction, such as different geographic locations or areas. The payroll taxes imposed can be based on the address (e.g. the city and state) of the employee 104 and paid by the first party user/employer 102 via electronic funds transfer also known as EFT, to appropriate Federal and state tax server repositories.

Depending upon the location of the employer 102 the amount of payroll tax for an employee can vary greatly. For example an employer in California is responsible for paying state tax requirement for employee 104 which may include state income tax deduction, state disability tax, unemployment tax and employment training tax. In some jurisdictions such as in Nevada the employer may not be subject to any required state income tax withholding liability.

Therefore the system 100 being pre-programmed with necessary employer/employee information, can determine if a tax is owed and if so, allow for the first party user/employer 102 to pay the amount of required tax based on pre-determined and pre-programmed software on the data content server 106.

As an example of paying any income or other employer required taxes, when the employer 102 activates and authorizes payroll through voice command for payment to the recipient 104 a calculated amount pre-programmed on data content server 106 the total amount that the employer 102 pays, will be based on recipient/employee earnings for a given period, with the necessary payroll deductions calculated on pre-programmed data content server 106. Upon completion of payroll execution through voice command, the employer 102 makes necessary payments through electronic funds transfer system (EFT) after the necessary payroll tax deductions are calculated and withheld from the employee/recipient 104 net amount of pay. The net amount of pay is then transferred from the employer bank account server 109 and transferred electronically into the employee bank account server 108. The employee/recipient 104 will be then notified of the preceding transaction executed by the employer 102.

The process of executing electronic funds transfer from employer bank account server 109 and employee bank account server 108 can occur over a network 110, such as one or more of the Internet, local area network, (LAN), wide area network (WAN), other wireless and wired networks, or combinations thereof.

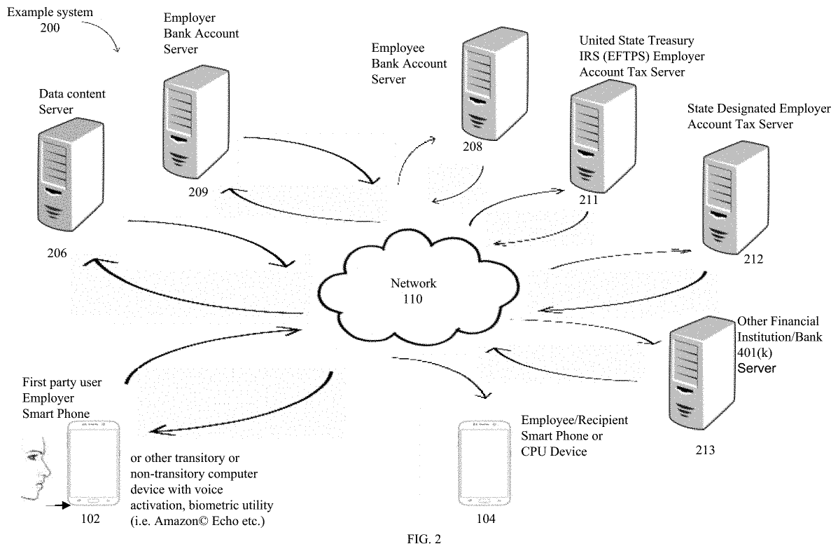

In some implementations, the payment of pre-determined employer tax requirements, specific depositing schedule requirements, and withheld employee tax withholding requirements can be made at various scheduled times dependent upon certain specific employer requirements. Such requirements as relating to scheduled requirements are such things as weekly, bi-weekly, monthly or quarterly depositors. In an example of how this can vary, FIG. 2 depicts the overall example system 200 which includes first party user employer smartphone 102, data content server 206, employer bank account server 209, employee bank account server 208, United States Treasury IRS employer tax account server 211, state designated employer account tax server 212. If recipient/employee 104 has been paid on a weekly payroll schedule time frame, and the employer 102, for example purposes, is a monthly scheduled payroll tax depositor, then payments to US Treasury IRS employer tax account Server 211 and state designated employer tax account server 212 will vary in timeframes from withdrawals from employer bank account server 209 to electronic funds transfers (EFT) deposits to employee bank account server 208. If an employer 102 is required to make a scheduled tax deposit prior to, or subsequently after a payroll period has been completed to an employee 104, the system can execute the tax requirement payments in similar fashion to making an electronic funds transfer (EFT) to an employee bank account server 208. When the pre-determined, scheduled tax payment amount(s) is/are required by the governing tax entity of Federal and/or state requirements, the employer 102 can authorize payment verbally to be executed by the pre-programmed data content server 206 through the network 110 in which the employer bank account server 209 will electronically transfer and deposit appropriate amounts into US Treasury IRS employer tax account server 211 and any state designated employer tax account server 212. The frequency of these types of tax deposits vary as per employer requirements thus the process can be executed separately from any payments or notifications made to employee/recipient 104.

Other examples of the systems as also shown in FIG. 2 would depict such electronic funds transfer and deposits to employee financial institution 401(k) other server 213, depending upon pre-determined parameters for other employer/employee payroll compensation agreements and requirements.

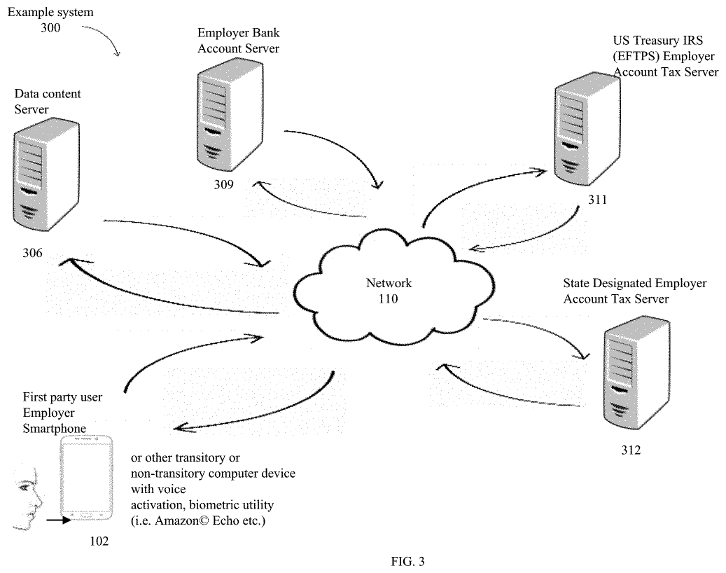

A simplified example shown in FIG. 3 is the tax deposit example system 300 that includes employer 102, data content server 306, employer bank account server 309, US Treasury IRS employer account tax server 311, state designated employer account tax server 312, and depicts how this function of payroll employer tax requirements are made from an employer only, tax deposit function and does not include an employee bank account server or recipient/employee device.

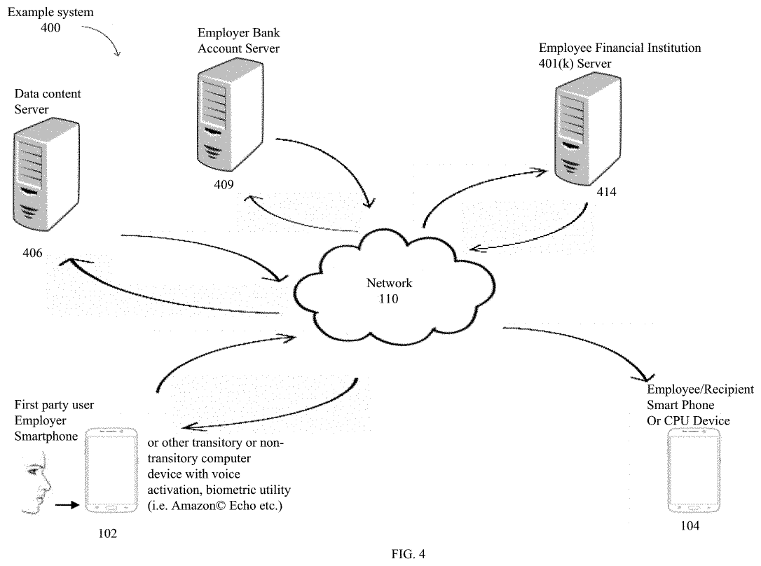

The example shown in FIG. 4 is the retirement contribution example system for making an appropriate contribution to the employee's 401(k) retirement account that includes the employer 102, data content server 406, employer bank account server 409, employee financial institution 401(k) other server 414, and employee/recipient device 104. In the example system 400, the employer 102, verbally executes a command to the data content server via the network 110 to execute an electronic funds transfer from the employer bank account server 409, to the employee financial institution 401(k) other server 414, with a pre-determined contribution amount. The employee/recipient device 104 would be notified upon completed transaction.

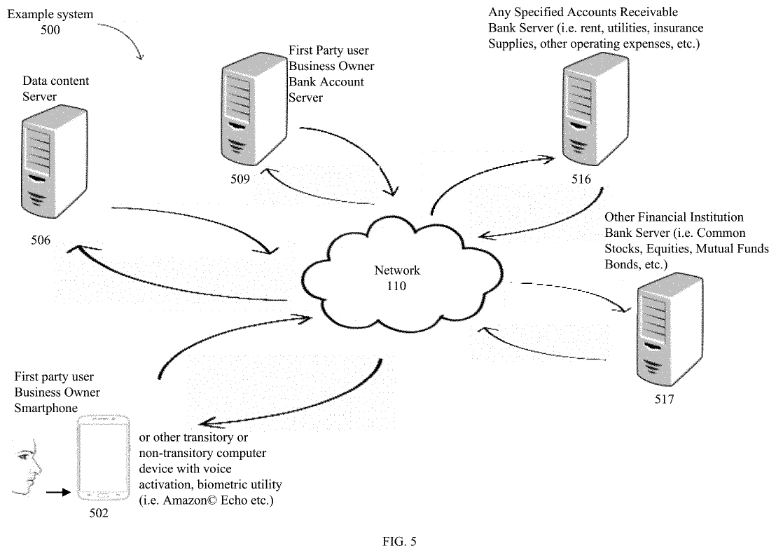

In an example in FIG. 5, the first party/business owner 502 can also make electronic funds transfers to any predetermined, specified accounts payable accounts as a business owner, for such things as rent, utilities, insurance and other typical business operating expenses.

In example system 500, the business owner 502, verbally executes a command to the data content server 506 which then executes an electronic funds transfer from business owner bank server 509 to any specified accounts receivable bank server 516 with a specified payment, to say for example, a business liability insurance policy. In another example in FIG. 5 the first party user/business owner 502 can also make a specified electronic funds transfer to other financial institution server 517, to purchase common stocks, equity funds or contribute funds to other investment assets held in a typical financial equity portfolio such as a business dedicated Roth IRA plan or other equity investment.

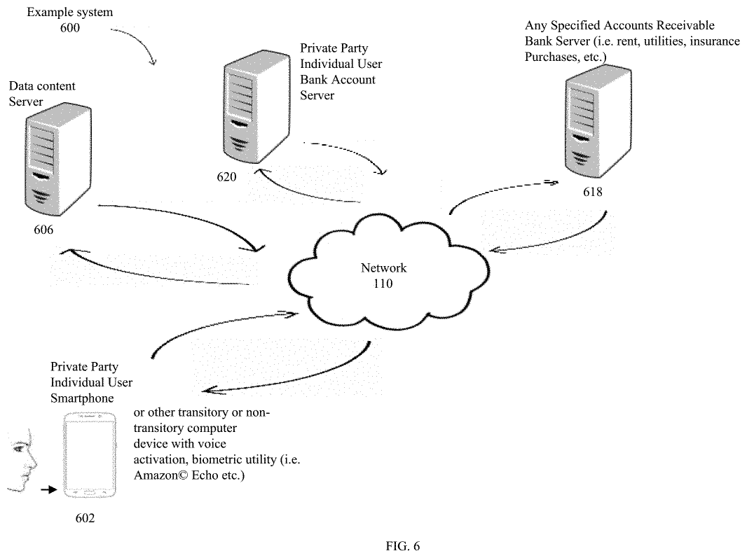

In an example in FIG. 6, the private party/individual user 602 can also make electronic funds transfers to any predetermined, specified accounts payable accounts as a private party/individual user, for common bill pay functions for such typical expenditures as rent, utilities, insurance and other common living expenses.

In example system 600, the private party/individual user 602, verbally executes a command to the data content server 606 which then executes an electronic funds transfer from private party individual bank account server 620 to the any specified accounts receivable bank server 618 with a specified payment, to say for example, a homeowner mortgage payment or an automobile loan payment.

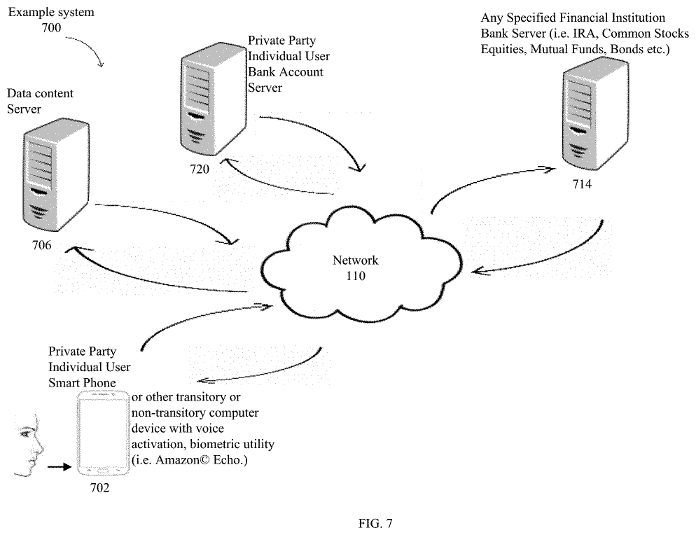

In another example in FIG. 7 the private party individual user 702 through pre determined voice biometric command, can also make a specified electronic funds transfer (EFT) to other financial institution server 714, to purchase common stocks, equity funds or contribute funds to other investment assets held in a typical financial equity portfolio such as a business dedicated Roth or standard IRA plan or other equity investment.

In example system 700, the private party/individual user 702, makes the voice input to either the smartphone or non-transitory, voice biometric programmed device which sends a command signal through the network 110, to the pre-programmed data content server 706 to execute an EFT from the private party/individual owner bank account server to the specified financial institution bank server 714, for the purpose of purchasing equities, common stocks, mutual funds, bonds and or retirement account equities through the EFT banking network system.

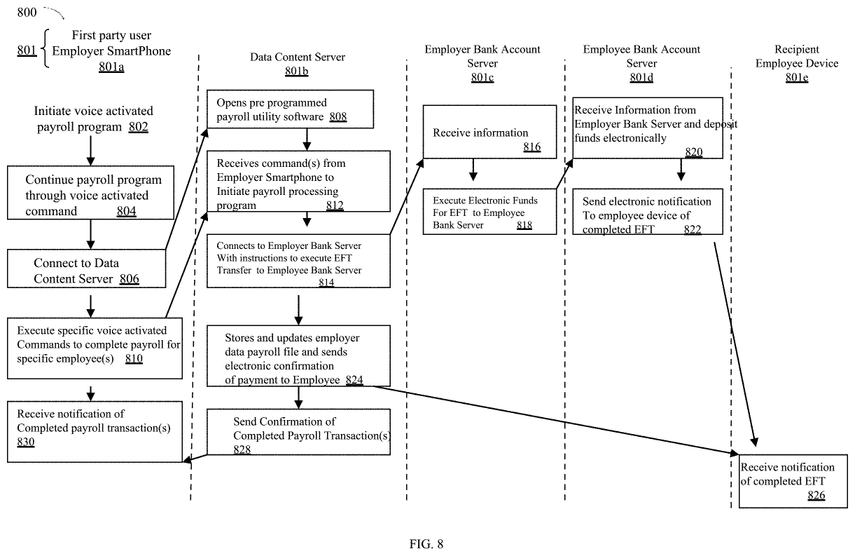

FIG. 8 is a swim-lane diagram of an example process 800 for voice activated payroll electronic funds transfer. For example, the process 800 can be used by an employer to execute a payroll transaction to pay an employee through the EFT system and direct deposit funds to the employee's bank account server 801d and send notification to Employee Device 801e.

FIG. 8 shows lanes for steps that can be performed by entities, 801, including the first party user/employer smartphone 801a, data content server 801b, employer bank account server 801c, employee bank account server 801d and recipient/employee device 801e. Pre-programmed payroll software is 808, is stored and operable by the data content server 801b. Referring to FIG. 1, for example, the pre-programmed payroll software is stored and accessible to the first party user/employer smartphone 102, on the data content server 106. Through voice activation the first party user/employer smart phone initiates the voice recognized payroll program 802 which then begins the process 804 for the phone to connect 806 to the data content server, which initiates the payroll utility software 808 on the data content server 801b. The data content server 801b then receives command from first party user/employer smartphone 810 to execute the payroll processing program for specific employee(s) which includes pre-determined payroll parameters in place for specific employee(s). The data content server then continues the communication chain to the employer bank account server 801c with proper and pertinent information it receives 816 to process.

The employer bank account server then executes instructions for the proper electronic funds transfer, EFT, 818, for connection to the employee bank account server 801d. The employee bank account server 801d receives information from the employer bank account server 801c and deposits funds electronically into designated employee bank account server 820. The employee bank account server then sends notification of completed EFT 822 to recipient/employee device 801e. The recipient/employee device then receives notification of completed EFT transaction 826. As this process completes, the data content server stores and updates employer data payroll file and also sends confirmation of payment to employee device 824. The data content server 801b then sends confirmation of completed payroll transaction 828 to the first party user/employer smartphone which receives notification of completed payroll transaction(s) 830.

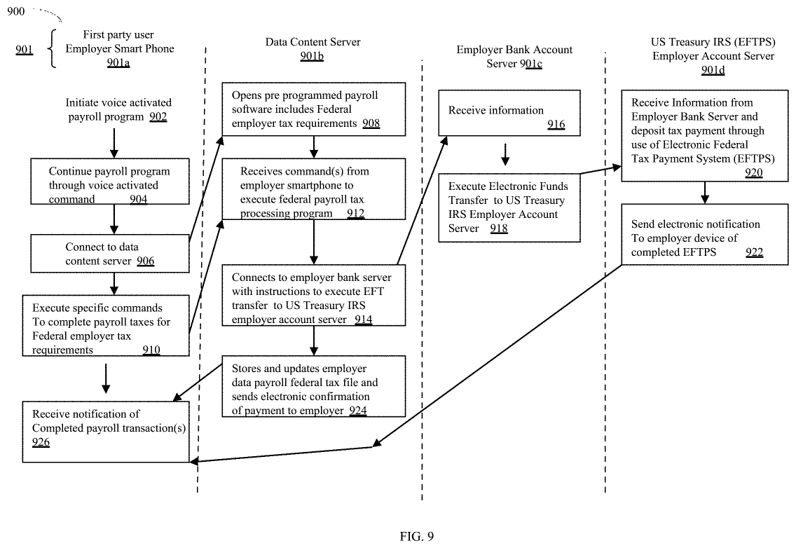

FIG. 9 shows lanes for steps that can be performed by entities, 901, including the first party user/employer smartphone 901a, data content server 901b, employer bank account server 901c and US Treasury IRS employer account server 901d.

Pre-programmed payroll software is 908, is stored and operable by the data content server 901b. Referring to FIG. 1, for example, the pre-programmed payroll software is stored and accessible to the first party user/employer smartphone 102, on the data content server 106. The first party user/employer smartphone initiates the voice activated Federal payroll tax program 902. Through voice activated user command, the first party user/employer smart phone continues the process 904 for the phone to connect 906 to the data content server, which opens the pre-programmed payroll utility software 908 on the data content server 901b. The first party user/employer smartphone then sends a voice activated command 910 to data content server 901b which receives command to execute the federal payroll tax withholding and employer contribution processing program for specific employee(s) with pre-determined payroll tax withholding and employer contributions 912.

The data content server 901b then continues communication 914 to the Employer bank server 901c with proper and pertinent information it receives to initiate process 916. The employer bank account server 901c then executes instructions for the proper electronic funds transfer, EFT, 918, for connection to the US Treasury IRS employer account server 901d. The US Treasury IRS employer account server 901d receives information from the employer bank account server 901c and deposits funds electronically into designated US Treasury IRS employer account server through the use of the Electronic Federal Tax Payment System (EFTPS) 920. The US Treasury IRS employer account server then sends notification of completed EFTPS 922 to first party user/employer smartphone. The data content server 901b stores and updates employer data payroll tax file and sends electronic confirmation of payment 924 to first party user/employer smartphone. The first party user/employer smartphone receives notification of completed payroll tax payment transaction 926.

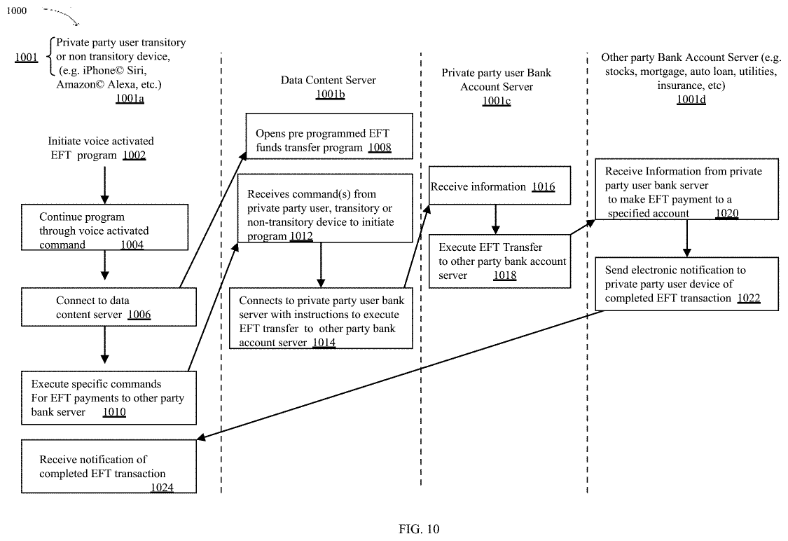

FIG. 10 shows lanes for steps that can be performed by entities, 1001 including private party user non-transitory voice activated device 1001a, data content server 1001b, private party user bank account server 1001c and other party bank account server 1001d. For illustration purposes, a data content server 1001b is pre-programmed with software for receiving voice activated commands from a private party user non-transitory computing device. (This software could ultimately be entirely available on a private party user smartphone and/or private party bank account server) for all intent and purposes it is depicted as available on a separate server.) Referring to FIG. 7, for example, pre-programmed bill pay software is stored and accessible to the first party/private user smartphone 702 and on the data content server 706.

The private party user non-transitory device is initiated through a voice activated command to begin the electronic funds transfer program 1002. Through pre-determined voice activated biometrics and/or voice recognized password input, the program continues to execute program 1004. The private party user transitory or non-transitory device through voice activated command, 1006, connects to the data content server. The data content server opens the preprogrammed EFT program from private party user transitory or non-transitory computing device instructions 1008. The private party user device then gives specific instructions 1010, to the data content server to execute EFT to other party bank server. The data content server receives the command(s) 1012, from the private party user device to initiate program to connect to the private party user bank account server 1014. The private party user bank account server receives information 1016 and executes EFT to other party bank account server 1018, to purchase common stocks, equities, pay home mortgage, automobile loan, utilities, health insurance and/or other common living expense payments.

The other party bank account server receives information 1020, from private party user bank account server to make a specified EFT to a specified account. The other party bank account server then sends electronic notification to private party user device of completed transaction 1022. The private party user transitory or non-transitory device receives notification of completed EFT transaction 1024.

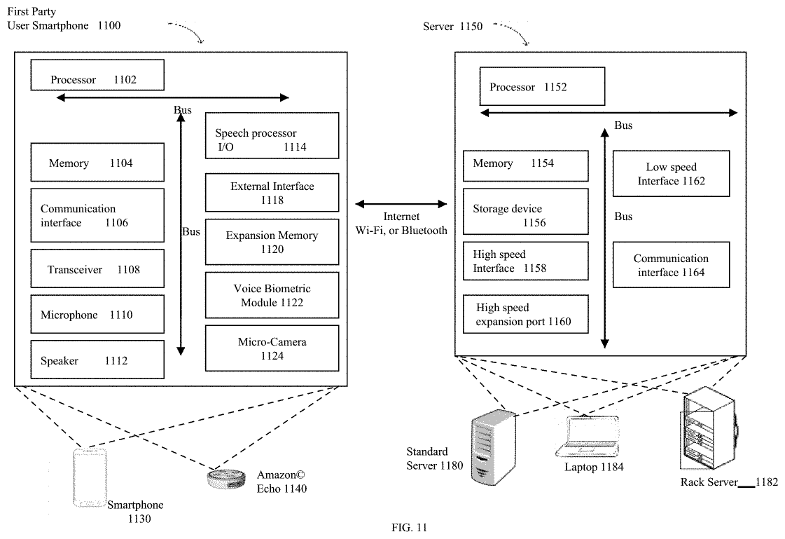

FIG. 11 shows an example of a generic mobile smartphone computing device 1100 and a generic non-transitory, data content server computing device 1150, which may be used to implement the processes described herein, including the mobile-side and server-side processes for executing the voice activated payroll program system. Computing device 1100 is intended to represent various forms of mobile devices, such as smart phones and also non-transitory, voice biometric, voice activated computing devices, such as iPhone© Siri and Amazon© Alexa, which already include voice biometric software and can include specific instructions and programming that when instructed can implement and connect to computing device 1150 to execute the described functionality. Computing device 1150 is intended to represent digital computers such as a server, laptop, desktop or workstation or other appropriate computers which would have the capacity to store and implement the payroll program system as described in the descriptions. A computer program product can be tangibly embodied in an information carrier as a server, desktop, laptop or workstation. The computer program product may also contain instructions that when executed by voice activation and voice command, perform one or more of the methods such as those described in the description.

The components shown here, their connections and relationships, and their functions, are meant to be exemplary only, and are not meant to limit implementations of the invention described and/or claimed in this document.

Computing device 1100 includes a processor 1102, memory 1104, communication interface 1106, a transceiver 1108, a microphone 1110, a speaker 1112, a speech processor input/output 1114, among other components. The device 1100 may also be provided with a storage device, such as a microdrive 1116, or other device, to provide additional storage. Each of the components, 1100, 1102, 1104, 1106, 1108, 1110, 1112, 1114, and 1116, are interconnected using various busses, and several of the components may be mounted on a common motherboard or in other manners as appropriate.

The processor 1102, can execute instructions within the computing device 1100, including instructions stored in the memory 1104. The processor may be implemented as a chipset of micro-chips that can include separate and/or multiple analog and digital processors. The processor may provide, for example, coordination of the other components of the device 1100, such as control of user interface, applications run by device 1100, through an appropriate micro-wave or radio frequency connectivity by device 1100.

Processor 1102 may communicate with a user through communication interface 1106 and speech processor 1114. The communication interface 1106 may receive voice actuated commands from a user and convert them for submission to the processor 1102. In addition, an external interface 1118 may be provided in communication with processor 1102, so as to enable near area communication of device 1100 with other devices. External interface 1118 may provide, for example for wireless communication in other implementation, and multiple interfaces may also be used.

The memory 1104 stores information within the computing device 1100. The memory 1104 can be implemented as one or more of a computer-readable, voice recognition medium, a volatile memory unit or units, or a non-volatile memory unit or units. Expansion memory 1120 may also be provided and connected to device to provide extra storage, or may store applications or other information for device 1100. Specifically expansion memory may include instructions to carry out or supplement the processes described above, and may include secure information also. Thus, for example, expansion memory 1120 may connect to voice biometrics module 1122 as a security feature for device 1100, and may be programmed with instructions that permit secure use of device 1100 through voice recognition biometric methods. Device 1100 can also be coupled to an internal micro-camera 1124 with an appropriate added software module for facial recognition and/or fingerprint scanning features for increased security measures.

Computing device 1100 may communicate wirelessly through communication interface 1106, which may include digital signal processing circuitry where necessary. Communication interface 1106 may provide for communications under various modes or protocols, such as GSM, SMS, EMS or MMS messaging, CDMA, TDMA, PDC, WCDMA, CDMA2000, or GPRS among others. Such communication may occur, for example, through radio-frequency transceiver 1108. In addition, short-range communication may occur, such as using Bluetooth, Wi-Fi, or other such transceiver (not shown).

The computing device 1100 may be implemented in a number of different forms, as shown in the figure. For example it may be implemented as a smartphone 1130. It may also be implemented as part of a wireless communication system connected through radio frequency and voice biometric activation such as a remote smart speaker such as Apple© Homepod, Amazon© Echo or other similar devices 1140.

Computing device 1150 includes a processor 1152, memory 1154, storage device 1156, high speed interface 1158, high speed expansion port 1160, and a low speed interface 1162, connecting through an appropriate bus to storage device 1156 through the communication interface 1164 that receives commands from first party user/employer smartphone computing device 1100 (not shown). Each of the components, 1152, 1154, 1156, 1158, 1160, 1162, and 1164 are interconnected using various busses, and may be mounted on a common motherboard or in other manners as appropriate. The processor 1152, can process instructions for execution within the computing device 1150, including instructions stored in the memory 1154, or on the storage device 1156, and/or through instructions through voice activated commands by the first party/employer smartphone computing device 1100, coupled to high speed interface 1158 and low speed interface 1162 to execute desired function(s) of described invention. In other implementations, multiple processors and/or multiple busses may be used, as appropriate, along with multiple memories and types of memory. Also, multiple computing devices 1150 may be connected, with each device providing portions of the necessary operations (e.g., as a server bank, a group of blade servers, or a multi-processor system).

The memory 1154 stores information within the computing device 1150. In one implementation, the memory 1154 is a volatile memory unit or units. In another implementation, the memory 1154 is a non-volatile memory unit or units. The memory 1154 may also be another form of computer machine readable medium.

The storage device 1156 is capable of providing mass storage for the computing device 1150. In one implementation, the storage device 1156 may be or contain a computer program that can be tangibly embodied. The computer program (e.g. payroll direct deposit processing, electronic federal tax payment and retirement contribution deposit/purchase) that when executed, can perform one or more of the methods, such as those described above.

The high speed interface controller 1158 manages bandwidth-intensive operations for the computing device 1150, while the low speed interface controller 1162 manages lower bandwidth-intensive operations. Such allocation of functions is exemplary only. In one implementation, the high speed interface controller 1158 is coupled to memory 1154, high speed expansion port 1160 and communication interface 1164 to communicate with other dedicated servers to execute appropriate instructions to complete designated electronic funds transfer function.

The computing device 1150 may be implemented in a number of different forms, as shown in the figure. For example, it may be implemented as a standard server, 1180, or multiple times in a group of such servers. It may also be implemented as part of a rack server system 1182. In addition it may be implemented in a personal computer such as a laptop computer 1184. Alternatively, components form computing device 1150 may be combined with other components in a mobile smartphone device (not shown) such as device 1100. Each of such devices may contain one or more of computing device 1100, 1150 and an entire system may be made up of multiple computing devices 1100, 1150 communicating with each other.

Various implementations of the systems and techniques described here can be realized in digital electronic circuitry, integrated circuitry, specially designed ASICs (application specific integrated circuits), computer software and/or combinations thereof. These various implementations can include implementation in one or more computer programs that are executable and/or implementable on a computer programmable processor, which may be special or general purpose, coupled to receive data, and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” computer-readable medium” refers to any computer product, apparatus and/or device (e.g., memory, Programmable Logic Devices (PLD's) et al), used to provide machine instructions and/or data to a programmable processor, including a machine-readable medium that receives machine instructions as a machine-readable signal. The term “machine-readable signal” refers to any signal used to provide machine instructions and/or data to a programmable processor.

The provided interaction with the primary user, the recipient, and other components of the systems and techniques described here is through voice activation, voice recognition, and voice biometric, et al, commands, which essentially is auditory input. Feedback from the system provided to the user and recipient would be such, but not limited to auditory feedback, visual feedback, or tactile feedback.

The systems and techniques described here can be implemented in a computing system that includes a back end component (e.g., as a data server), or that includes a middleware component (e.g., an application server such as bank or US Treasury IRS EFTPS server) or that includes a front end component (e.g., a first party/employer smartphone, (i.e. transitory computing and communication device), having the voice activated program module through which the user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”) and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, the described systems. Accordingly, other implementations are within the scope of the following claims.

Elements of different implementations described herein may be combined to form other implementations not specifically set forth above. Elements may be left out of the processes, computer programs, etc., described herein without adversely affecting their operation. Furthermore, various separate elements may be combined into one or more individual elements to perform the functions described therein.

The invention will allow business users who may also be employers, as well as individual users, a voice activated, voice biometric method to complete entire payroll functionality from electronic processing payments of employee's pay through electronic funds transfers (EFT) function of existing bank services, as well as executing other payroll functions such as but not limited to, payroll related tax of federal and state deposit requirements and other payroll contributions such as 401(k) retirement fund contributions through the use of common mobile transitory and non-transitory, communication and computing device methods.

The purpose of the invention is to create voice activated, electronic payroll and other common business accounts payable payment functions through voice activated and voice recognized (biometric) electronic funds transfer processing for employers as well as other personal users.

This system can also be applied to making voice activated, voice biometric electronic currency or electronic funds transfers (EFT's) including but not limited to other transactions such as purchasing equities, common stocks, retirement funds, mutual funds, and other similar type equities traded on existing financial exchanges.

The present invention will also provide a visually impaired user to execute said functions as present voice recognition technology is available but does not yet exist in current stated form(s).

What is claimed is:

1. A software enabled, voice activated, mobile or stationary computing device will connect to an authenticated server(s) through a secure network with pertinent employer information and specific employee payroll information, (i.e. personal identification, social security or tax identification number, federal and state deductions, withholdings and/or exemptions, filing status, pay period, base salary or wage, hours worked, overtime) for the purpose of executing common business payroll function. Through pre programmed payroll software on a dedicated employer server and/or through existing various payroll services, that among many features, will calculate and execute necessary employer and employee deductions and other voluntary contributions, and execute payments in regards to employer tax requirement payments and other voluntary payments, i.e. 401(k) retirement plans, health insurance payments, other, and employee salary or wage payment through electronic funds transfer (EFT), electronic federal tax payment system (EFTPS) and any state tax payment electronic funds transfer through a series of voice activated, voice recognized, voice biometric commands from an employer smart phone or non-transitory voice activated computing device.

2. Access employer payroll data base through voice biometric activated command to execute machine readable interface software application function for electronic funds transfers (EFT) through the financial electronic data interchange (FEDI) using voice biometric, speech recognition, activated command to execute employer payroll direct deposit to employee personal bank account through EFT, FEDI using voice biometric activated command and execute employer Federal and state tax payment requirements through EFT, FEDI and the Electronic Federal Tax Payment System (EFTPS) and any state electronic funds transfer systems. The program will also be able to execute business income tax payments, weekly, monthly, quarterly and/or yearly as required as a registered business through the use of existing EFT, FEDI and EFTPS.

3. Execute employer retirement 401(k) and/or other employer contribution to employee through EFT and FEDI using voice biometric activated command. As well as executing business accounts payable transactions to other service and utility providers. It will also allow visually impaired users to access stated claims through voice biometric, voice activated, speech recognized commands to also execute personal expenditure payments as well as common stock and equity type purchases.

4. (canceled)

5. (canceled)

6. (canceled)

7. (canceled)

8. (canceled)

9. (canceled)

10. (canceled)

11. (canceled)

12. (canceled)

13. (canceled)

14. (canceled)
